(19) United States
(12) Patent Application Publication
(10) Pub. No.: US 2007/0014311 A1
(43) Pub. Date: Jan. 18, 2007

(54) Method and apparatus for grouping messages across a point to multipoint network

(76) Inventors: Juergen Voss, Wiesbaden (DE); Per Kangru, Uppsala (SE)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/179,636

(22) Filed: Jul. 13, 2005

(51) Int. Cl. H04J 3/24

(52) U.S. Cl. 370/473

(57) ABSTRACT

A method and apparatus for grouping signaling messages across a point to multipoint network. The signaling messages across a point to multipoint network are correlated into a session based on respective call information of the signaling messages and the signaling messages including summarized traffic information in relation thereto are displayed using a graphical user interface.

### BACKGROUND OF THE INVENTION

### Description of the Related Art

Generally, a point to multipoint network connects one user with multiple users in a one to many configuration. Network analysis of a point to multipoint network is important to ensure reliability and performance of the point to multipoint network.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a process of capturing and grouping signaling messages across a point to multipoint network, according to an embodiment of the present invention.

FIG. 2 is a diagram illustrating a process of correlating and displaying signaling messages of a point to multipoint network, according to an embodiment of the present invention.

FIG. 3 is a diagram illustrating a point to multipoint network, according to an embodiment of the present invention.

FIG. 4 is a diagram illustrating a graphical user interface for displaying signaling messages of a point to multipoint network, according to an embodiment of the present invention.

FIG. 5 is a diagram illustrating a graphical user interface for displaying grouped signaling messages of a point to multipoint network, according to an embodiment of the present invention.

FIG. 6 is a diagram illustrating selection of a call of a point to multipoint network, according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

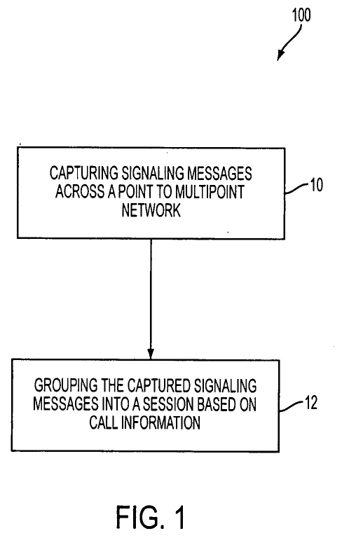

FIG. 1 is a diagram illustrating a process 100 of capturing signaling messages across a point to multipoint network and grouping the captured signaling messages into a session based on call information, according to an embodiment of the present invention. Referring to FIG. 1, in operation 10, signaling messages are captured across a point to multipoint network. For example, according to an embodiment of the present invention, signaling messages for each link in a point to multipoint network are captured. However, the present invention is not limited to capturing signaling messages for each link in a point to multipoint network. For example, various embodiments of the present invention can be implemented to capture signaling messages of a particular interface (i.e., lu, lur or lub interface) of a point to multipoint network.

The term “point to multipoint network” indicates a communication network configured to transmit data from a single source to multiple destinations. A point to multipoint network includes, for example, TETRA (terrestrial trunked radio), PTT (push-to-talk), ASCII networks, etc. However, the present invention is not limited to any particular type of point to multipoint network.

Referring to FIG. 1, from operation 10, the process 100 moves to operation 12, where the captured signaling messages are grouped into a session based on call information. The captured signaling messages can be grouped using various elements corresponding to call information of the signaling messages, and thus, the present invention is not limited to grouping signaling messages using any specific element corresponding to call information of the captured signaling messages. For example, according to an embodiment of the present invention, signaling messages relating to a call are grouped based on call information in accordance with protocols and procedures used to set up, manage and release the call in a point to multipoint network, such as a calling party number, a called party number, a translated party number, a calling point code, etc.

Further, the present invention is not limited to grouping signaling messages of a particular interface(s) in a point to multipoint network. For example, in various embodiments of the present invention, signaling messages on an lub interface can be grouped with signaling messages of an lu interface and Gn interface of a 3GPP (third generation partnership project) lub, lu and Gn interface in a point to multipoint network. While grouping of signaling messages is described using a 3GPP lub, lu and Gn interface network, the present invention is not limited to grouping signaling messages of a specifically interfaced point to multipoint network. For example, in various embodiments of the present invention, ALCAP, RANAP/NAS, IuUP, IP frames and GCP messages can be grouped together in an lu and GCP interfaced network.

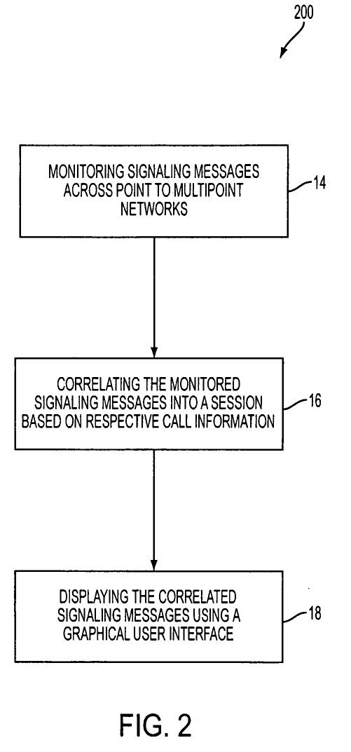

FIG. 2 is a diagram a diagram illustrating a process 200 for monitoring signaling messages across a point to multipoint network, correlating the monitored signaling messages into a session based on respective call information and displaying the correlated signaling messages using a graphical user interface, according to an embodiment of the present invention. Referring to FIG. 2, in operation 14, signaling messages across point to multipoint networks are monitored. For example, according to an embodiment of the present invention, signaling messages, such as SCCP (signalling connection control part), DTAP (direct transfer application part) and BSSMAP (base station subsystem management application part) messages, etc., are captured in a point to multipoint network. However, as mentioned above, the present invention is not limited to capturing any particular types of signaling messages.

Referring to FIG. 2, from operation 14, the process 200 moves to operation 16, where the monitored signaling messages are correlated into a session based on respective call information. The monitored signaling messages can be correlated using various elements of call information of the signaling messages, and thus, the present invention is not limited to being correlated using any particular element of the monitored signaling messages. For example, in various embodiments of the present invention, signaling messages of a call are correlated based on respective call information such as called and calling party BCD number, service type, domain, SCCP data, signaling message identification, call type and status, RANAP (radio access network application part) data, setup and clear down time of a communication, etc. Further, various embodiments of the present invention can be implemented to correlate signalling messages based on call information including corresponding IMSI (international mobile subscriber identity), IMEI (international mobile equipment identity), Node B communication context identification information, CRNC (controlling radio network controller), etc., and thus is not limited to monitoring signaling messages based on any particular element of corresponding call information.

Referring to FIG. 2, from operation 16, the process 200 moves to operation 18, where the correlated signaling messages are displayed using a graphical user interface. The correlated signaling messages can be displayed using various graphical user interfaces. For example, in various embodiments the present invention, the correlated signaling messages can be displayed in a tabular structure. However, the present invention is not limited to displaying signaling messages in a tabular structure. For example, in various embodiments of the present invention, signaling messages can be displayed using a graph.

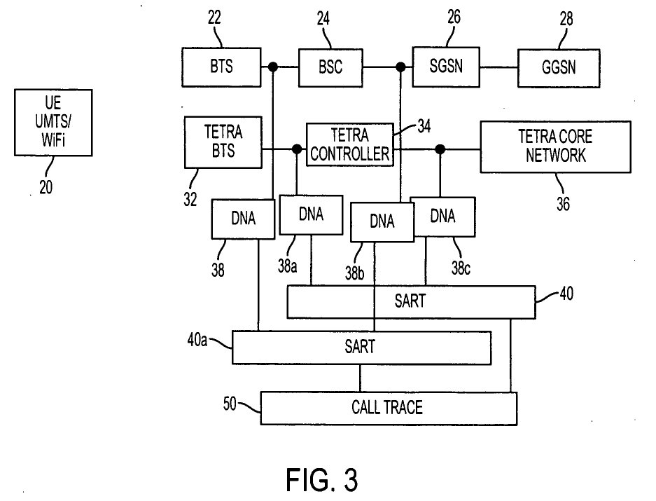

FIG. 3 is a diagram illustrating a point to multipoint network, according to an embodiment of the present invention. As shown in FIG. 3, the point to multipoint network includes a UMTS (universal mobile telecommunications system) or UE (user equipment) 20, a BTS (base transceiver) 22, a BSC (base station controller) 24, a SGSN (serving GPRS support node) 26 and a GGSN (gateway GPRS support node) 28. However, the present invention is not limited to a point to multipoint network configuration illustrated in FIG. 3. For example, various embodiments of the present invention can be implemented in point to multipoint networks with multiple UE, BTS, SGSN and GGSN. General functions of a UE/UMTS, BTS, BSC, SGSN and GGSN are well known.

Referring to FIG. 3, the BTS 22 is connected with the BSC 24 that in turn is connected to the SGSN 26 via a communication interface. Further, the SGSN 26 is connected with the GGSN 28. As also illustrated in FIG. 3, the point to multipoint network includes a TETRA core network 36 is connected to a TETRA BTS 32 via a TETRA controller 34. While FIG. 3 is described with respect to a TETRA network, the present invention is not limited to a TETRA network. For example, in various embodiments of the present invention, signaling messages of various types of point to multipoint networks including PTT, ASCII, etc., are grouped together.

FIG. 3 also illustrates that distributed network analyzers (DNAs) 38, 38a, 38b and 38c connected with a communication line transmitting data between the TETRA BTS 32, the TETRA controller 34 and TETRA core network 36 and a communication line connecting BTS 22, BSC 24, SGSN 26 and GGSN 28.

In FIG. 3, signaling analyzer real time software (SART) 40 is connected with DNA 38a and DNA 38c and SART 40a is connected with DNA 38 and DNA 38b. However, the present invention is not limited to providing a particular number of DNAs and SARTs to a point to multipoint network. Further, the present invention is not limited to any specific type of DNA or SART for capturing signaling messages of a point to multipoint network

A call trace 50 is connected with SART 40 and SART 40a to group signaling messages of a point to multipoint network based on respective call or data session information. For example, the call trace 50 identifies elements of a particular call(s), such as start time, service type, release cause, user zone, airlink priority, authentication status, A11 request, A11 setup success ratio, user name, MS IP address, care of address, home agent, MIP registration code, IP type, call type, etc., and groups signaling messages related to the call based on the elements. Further, the call trace 50 is not limited to grouping signaling messages of any particular protocol used in a point to multipoint network. For example, various embodiments of the present invention can be implemented for grouping signaling messages for ALCAP (access link control application part), Node B application part (NBAP) and other protocols being used in a point to multipoint network.

The call trace 50 also captures signaling messages across a point to multipoint network in response to a user's request. For example, the call trace 50 checks signaling messages across a point to multipoint network to determine whether the signaling messages contain protocol(s) specified in the user's request and groups the signaling messages transferred using the requested protocol(s) into a call or session.

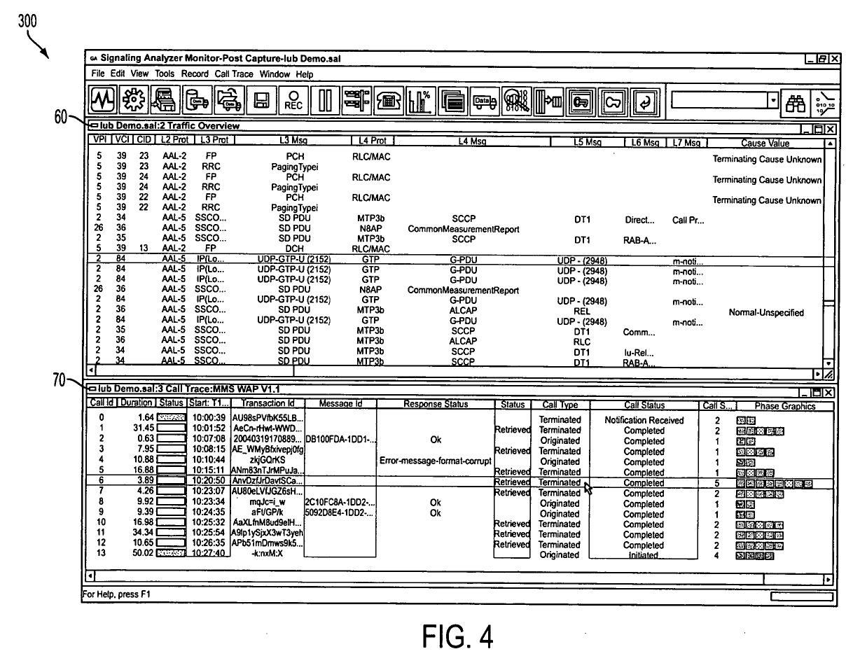

FIG. 4 is a diagram illustrating a graphical user interface 300 for displaying signaling messages of a point to multipoint network, according to an embodiment of the present invention. Referring to FIG. 4, a window 60 displays information of signaling messages across the point to multipoint network in accordance with call information of the signaling messages including path identifier, port information, channel identifier, cause value, etc. For example, when a user requests MMS call traces to group signaling messages and traffic data related to a specific call, the call trace 50 of FIG. 3 captures signaling messages for at least one monitored interfaces (lu, lur or lub) and displays signaling messages as illustrated in the window 60 of FIG. 60. The user is then able to select a call from the displayed signaling messages of the MMS trace 70 to group MMS messages and traffic related to the call.

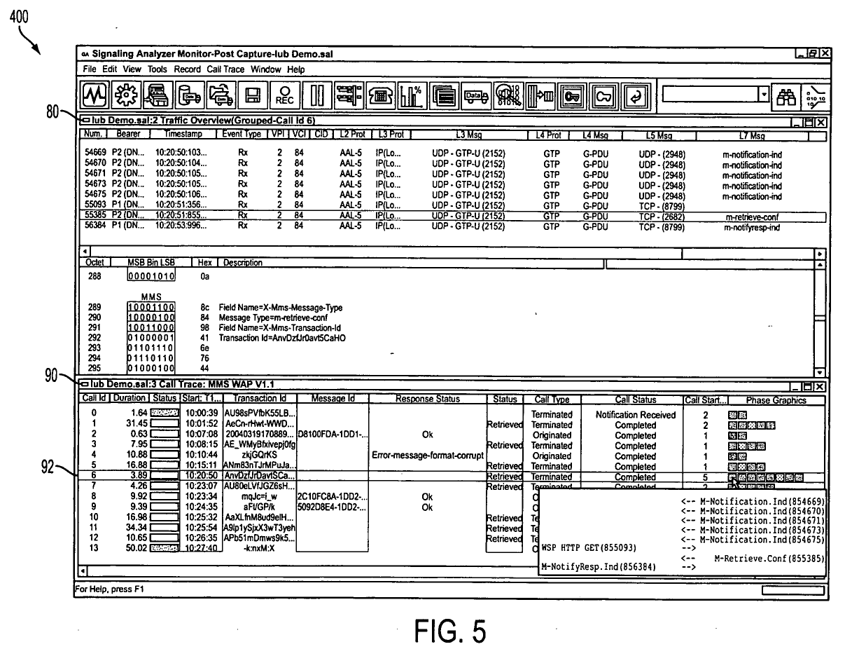

FIG. 5 is a diagram illustrating a graphical user interface 400 for displaying grouped signaling messages of a point to multipoint network, according to an embodiment of the present invention. Referring to FIG. 5, when a user selects a call 92 from calls displayed in a window 90, the user is provided with a window 80 that displays grouped traffic overview of signaling messages based on the call 92. As shown in window 80 of FIG. 5, the grouped traffic overview of the signaling messages includes various data of the call 92, such as time information, event type, path and channel identifier, port, etc. However, the present invention is not limited to displaying any particular signaling messages with respect to a call. For example, in various embodiments of the present invention, traffic overview of signaling messages is displayed based on call identifier, call status, call duration, routing area code, and other values with respect to a call.

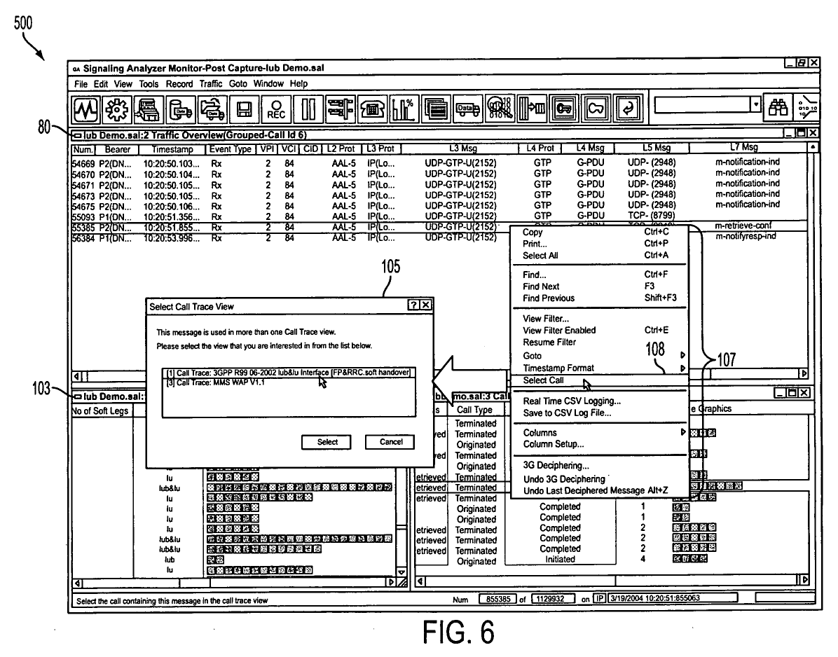

FIG. 6 is a diagram illustrating selection of a call of a point to multipoint network, according to an embodiment of the present invention. Referring to FIG. 6, a window 500 is provided to display a traffic overview of signaling messages of a point to multipoint network. A user is enabled to select a call pertaining to a signaling message using a pop-up window 107 that lists options for configuring a call. Further, the present invention indicates when a signaling message of a call is used with respect to more than one call by displaying a window 105. When a signaling message is associated with more than one call, as indicated in window 105 of FIG. 6, the present invention correspondingly indicates the signaling message with respect to each call. For example, when a signaling message of a call is used in both 3GPP and MMS calls, the signaling message is correspondingly displayed in with respect to the 3GPP and MMS call.

Accordingly, a method and apparatus for grouping signaling messages into calls or sessions is provided. This allows the grouped signaling messages to be displayed to a user, thereby providing a mechanism of ensuring reliability and performance of a point to multipoint network. Further, the present invention captures signaling messages across a point to multipoint network including a TETRA, PTT and ASCII network, and groups the captured signaling messages into a session based on call information in the captured signaling messages.

Various embodiments of the present invention provide a signaling analyzer including a graphical user interface providing summarized traffic data of signaling messages across a point to multipoint network, wherein the signaling messages are grouped into a session based on call information of the grouped signaling messages. This enables display and configuration of the grouped signaling messages including call setup and call tear down information corresponding to the signaling messages. Further, according to an embodiment of the present invention, the summarized traffic data of signaling messages is configured using a call trace.

Further, in various embodiments the present invention provide a method of monitoring signaling messages across point to multipoint networks, correlating the monitored signaling messages into a session based on respective call information of the monitored signaling messages, and displaying the correlated signaling messages using a graphical user interface. This enables a user to analyze signaling messages of a point to multipoint network for detection and troubleshooting problems within the network without allocating a significant amount of time to scan through and determine each signaling message with respect to a call or session.

Accordingly, a method and apparatus for grouping signaling messages of a point to multipoint network based on respective call information is provided. This is enables analysis of a point to multipoint network ensuring performance and reliability of the point to multipoint network.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method, comprising:
capturing signaling messages across a point to multipoint network; and
grouping the captured signaling messages into a session based on call information in the captured signaling messages.

2. The method according to claim 1, wherein said point to multipoint network is one of a TETRA, PTT or ASCII network.

3. The method according to claim 1, further comprising:
displaying the grouped signaling messages including call setup and call tear down information of the grouped signaling messages.

4. The method according to claim 1, wherein said grouping comprises:
configuring the captured signaling messages using a call trace.

5. The method according to claim 1, wherein said grouping comprises:
grouping the captured signaling messages responsive to a user's selection of the signaling messages.

6. The method according to claim 1, wherein said grouping comprises:
grouping the captured signaling messages in real-time.

7. The method according to claim 6, wherein said grouping comprises:
grouping the captured signaling messages based on corresponding binding identification data.

8. A method, comprising:
monitoring signaling messages across point to multipoint networks;
correlating the monitored signaling messages into a session based on respective call information of the monitored signaling messages; and
displaying the correlated signaling messages using a graphical user interface.

9. The method according to claim 8, wherein said point to multipoint networks include one or more of TETRA, PTT or ASCII networks.

10. The method according to claim 9, wherein said correlating comprises:
combining traffic information of the monitored signaling messages based on the respective call information of the monitored signaling messages.

11. The method according to claim 8, wherein said displaying comprises:
indicating predetermined data of a call using a tabular structure.

12. The method according to claim 9, wherein said correlating comprises:
grouping the monitored signaling messages based on corresponding binding identification data.

13. A signaling analyzer, comprising:
a graphical user interface providing summarized traffic data of signaling messages across a point to multipoint network, wherein the signaling messages are grouped into a session based on call information of the grouped signaling messages.

14. The signaling analyzer according to claim 13, wherein said point to multipoint network is one of a TETRA, PTT or ASCII network.

15. The signaling analyzer according to claim 13, wherein said graphical user interface displays the grouped signaling messages including call setup and call tear down information corresponding to the signaling messages.

16. The signaling analyzer according to claim 13, wherein said summarized traffic data of signaling messages is configured using a call trace.

17. The signaling analyzer according to claim 13, wherein said graphical user interface displays the summarized traffic data of the signaling messages using a tabular structure.

18. The signaling analyzer according to claim 13, wherein said summarized traffic data of signaling messages is implemented based on corresponding binding identification data.

19. The signaling analyzer according to claim 13, wherein said summarized traffic data of signaling messages is responsive to a user's selection of the signaling messages.

20. The signaling analyzer according to claim 13, wherein said graphical user interface displays statistical information of the signaling messages.
